(19) United States
(12) Patent Application Publication
(10) Pub. No.: US 2017/0245686 A1
(43) Pub. Date: Aug. 31, 2017

(54) AIR FRYER

(71) Applicant: NINGBO BIYI ELECTRIC APPLIANCE CO., LTD., Zhejiang (CN)

(72) Inventor: Kaimong MAN, Zhejiang (CN)

(73) Assignee: NINGBO BIYI ELECTRIC APPLIANCE CO., LTD., Zhejiang (CN)

(21) Appl. No.: 15/439,461

(22) Filed: Feb. 22, 2017

(30) Foreign Application Priority Data
Feb. 26, 2016 (CN) 201610104960.1

(51) Int. Cl. A47J 37/12

(52) U.S. Cl. CPC A47J 37/1257

(57) ABSTRACT

The present invention related to an air fryer, which is designed for solving technical matters existed among current similar products, such as weak structure design, safety and oil filter structures which need to be further improved. The pot body of the air fryer is integrated by pot housing, inner pot, outer pot and handle, and the engine body is integrated by upper casing, lower casing and base; the key point that is the inner diameter bottom of inner pot is equipped with oil-filter screen that is fixed by the clips inside the hole of inner pot; the handle and the pot housing is integrated through locking plate. The locking plate is L-shaped, with one end stick into the pot housing and fit with the metal sheet on the inner wall of the pot housing, and the other end against the locking sheet through tilted cover. The locking sheet at the handle side is tilted. When pressing the locking sheet, the locking plate will be driven by the tilted cover to rotate. When place the pot body into the engine body, the hook of the pot housing will fit with the hook hole of the base; the upper casing corresponding to the limiting diagonal bar of the handle is equipped with column plate, and the limiting column inside the upper casing sticks out of the column plate through the spring and against the slope side of the limiting diagonal bar.

### BACKGROUND OF THE INVENTION

The present invention related to an electric fryer, which is an air fryer.

The electrical fryer is a household appliance for frying various foods, such as meat, vegetable, fried dough twist and snacks, etc. With advantages as easy operation, rapid heating rate, the fryer is special equipment for snake bar, and a necessary kitchenware for modern life. While air fryer is a new household appliance for frying foods with application of high-speed air cycle technique. The air fryer is able to reduce 80% of oil and fat than that of food produced by traditional electric fryers. It is easy to clean, and is safe and economical, thus is favored by people. Such air fryer combine rapid cycle hot air and oven part uniquely, as disclosed in Chinese patent document—application number: 201310101037.9, application announcement date:2013 Jun. 12, invention name “A Smoke-free Air Fryer”.

The air fryer comprises fixed part and mobile part. The said air fryer has a top-moving power switch that is equipped at one lower side of the boss (for installing timer) at the front fixed part. The mobile part of the air fryer and food storage containers are locked, one upper side of the handle matched for unlocking is equipped with top-moving boss, and the top-moving boss is matched with top-moving power switch at one lower side of the boss of the fixed part. Flat spiral type electric heating tube is below the hot-air fan in the fixed part, whose power connector is connected with inner wall of the fixed part through connecting pieces. The tube body of the flat spiral type electric heating tube is elastically connected with inner wall of the fixed part through spring. The bottom center of the drip pan of the mobile part of the said air fryer is arc-shaped raised, with peripheral pot walls and the pot bottom to be arc-shaped. However, safety and cold-hot wind circulation structure, etc of the said air fryer are still need to be further improved.

### SUMMARY OF THE INVENTION

To over the said deficiencies, the invention is aimed to provide an air fryer, and solve problems among existing similar products such as weak structure design, safety and oil filter structure, etc. The goal is achieved by following technical solutions.

An air fryer, comprising lower casing, upper casing, blade motor, temperature switch, cold-air blade, hot-air blade, spiral electric heating tube, handle, inner pot, base, outer pot, pot housing; the said pot housing, inner pot, outer pot and handle are integrated into the pot body, while upper casing, lower casing and base are integrated into the engine body. The base is equipped with bottom cover. The side of base symmetrical with the handle is equipped with splicing sleeve, and the pot body is placed in the opening of one lower side of the engine body. The pot housing is arc-shaped; the pot housing and the engine body form a complete conical body which is small at the top and big at the bottom. The handle is appeared out of the engine body. The upper part of the engine body is equipped with spiral electric heating pipe and blade motor whose spindle is connected with cold-air blade and hot-air blade. Blow hot air inside the engine body into the inner spot by rotating cold-air blade and hot-air blade, and then be discharged. The cold air goes into the engine body, one part of the cold air be discharged, and the rest be heated to hot air; the key structure design is that the hemline of the outer pot beside the handle is equipped with flat key edges symmetrically, and flat key edges are corresponding to the through hole inside the upper casing. The through hole is located between inner diameter of interlayer cover and the external diameter of the heat shield cover. At two sides of upper casing above the through holes are symmetrical upper air-holes, and the base at two sides of splicing sleeves is equipped with lower air-holes. The gap between inner diameter of heat shield cover and external diameter of heating tube cover, and the heating tube is opposed to the pot mouth. The said gap between heat shield cover and heating tube cover is connected with external diameter of engine body through air outlet plate which is located at one side of the engine body symmetrical to the handle; the cold-air blade and hot-air blade inside the upper casing is separated by the heat shield cover, and the hot-air blade inside the upper casing is opposed to the air inlet hole of the heating tube cover. The air inlet hole of the heating tube is equipped with hot-air mesh, and the spiral heating tube is equipped inside the heating tube cover. The controller and blade motor are equipped inside the cavity between outer diameter of interlayer cover and inner diameter of upper casing. The upper casing top and the upper cover are inclined to the handle. The upper cover at the top of upper casing is equipped with temperature switch, which is partly appeared out of the arc-shaped groove at the top of upper casing. The upper casing at the handle side is equipped with time switch that is located at the engine body above the handle. Spiral electrical heating tube, temperature switch, time switch and blade motor are connected with controller through the line. The said structure has realized the hot-air and cold-air circulation with closing matching components, and is in accordant with requirements for heating and stability. In the same time, the air fryer is easy to assemble, to produce and to clean, with good heating and heat dissipation effect, and beautiful appearance.

The center of inner diameter bottom of the said outer spot is raised, and the inner diameter bottom of inner pot is equipped with oil-filter screen that is fixed by the clips inside the hole of inner pot. The hole of the inner pot is equipped with small eave whose diameter is smaller than the diameter of the oil filter screen. The said structure is easy for hot-air to enter into the inner pot after it entering into the outer pot and inner pot, and to have efficient and sufficient heating for foods on the oil filter screen; in the same time, the structure is easy for dismounting and cleaning the oil filter screen.

The said outer pot is connected with pot housing through the screw, and one side of the inner pot inside the outer pot is connected with handle through connecting pieces. The handle and the pot housing are connected through locking plate. The locking plate is L-shaped, with one end stick into the pot housing and fit with the metal sheet on the inner wall of the pot housing, and the other end against the locking sheet through tilted cover. The locking sheet at the handle side is tilted. The shaft end of the tilted cover insert into the plate hole of the locking plate, and the pivot at the curved point of the locking plate is fixed in the handle. When pressing the locking sheet, the locking plate will be driven by the tilted cover to rotate, and the locking part of the locking plate will be separated from the metal sheet. The said structure is easy to dismount the inner pot and outer pot, and to achieve good safety.

The bottom of the pot housing is equipped with housing hook, and the base corresponding to the hook is equipped with hood hole; when place the pot body into the engine body, the housing hook will be fit with hook hole of the base. The said structure is able to prevent the pot body from being taken out arbitrarily and improve the safety of the air fryer during the working

The handle at eave of the said housing is equipped with raised limiting diagonal bar, the upper casing corresponding to the limiting diagonal bar of the handle is equipped with column plate, and the limiting column inside the upper casing sticks out of column plate through the spring, and meets the beveled side of the limiting diagonal bar. The said structure is able to prevent ensure that the pot body not be taken out arbitrarily, which has further improved the safety of the air fryer during the working. In the same time, with matched housing hook at the bottom, the pot body can only been taken out by drawing out after driving the pot body tilted downward and outward through the handle.

The said cold-air blade and hot-air blade are plane blades with tilted back blades respectively. The back blade for cold-air blade is tilted upward; while back lade for hot-air blade is tilted downward. Meanwhile, the back blades are equipped with oriented punching tray respectively. The said structure has further improved the hot air and cold air circulation effect, and has reduced the space occupancy of blades.

The said upper casing between time switch and handle is equipped with indicator light, and base at two sides of the handle is equipped with corner groove respectively. The said structure is easy for indicating the working state of the air fryer, and for moving the air fryer.

The invention has reasonable designed structure, and is easy to produce, operate and clean, with good stability, safety and beautiful appearance; mainly used as air fryer, and for structure improvement of similar products.

### BRIEF DESCRIPTION OF THE DRAWINGS

FIG. 1 is cross-sectional view I of the invention; wherein, A part is framed, and arrows indicate the direction of hot air.

FIG. 2 is cross-sectional view II of the invention, wherein, arrows indicate the direction of cold air.

FIG. 3 is enlarged view of A part of FIG. 1.

FIG. 4 is three-dimensional structure view of the invention.

FIG. 5 is structural view of the invention when pot boy been taken out.

FIG. 6 is structural view I of the invention when pots been separated

FIG. 7 is structural view II of the invention when pots been separated

FIG. 8 is inner structural view of engine part of the invention.

Number and Name: 1. Lower Casing 2.Air Outlet Plate 3.Upper Casing 4.Upper Cover 5.Blade Motor 6.Temperature Switch 7.Cold-air Blade 8.Time Switch 9.Interlayer Cover 10.Hot-air Blade 11.Heat Shield Cover 12.Heating Tube Cover 13.Hot-air Mash 14.Spiral Electrical Heating Tube 15.Connecting Pieces 16.Locking Sheet 17.Tilted Cover 18.Locking Plate 19.Handle 1901.Limiting Diagonal Bar 20.Inner Pot 21.Oil Filter Screen 22.Base 23.Bottom Cover 24.Splicing Sleeve 25.Outer Pot 26.Pot Housing 2601.Housing Hook 27.Limiting Column 28.Column Plate

### DESCRIPTION OF THE PREFERRED EMBODIMENT

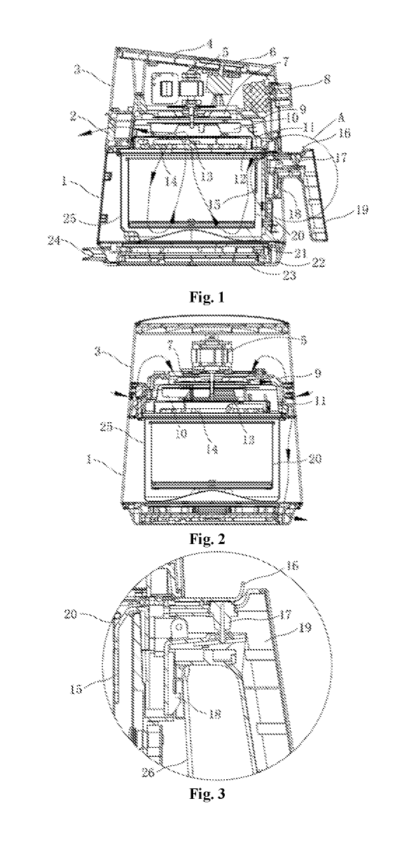

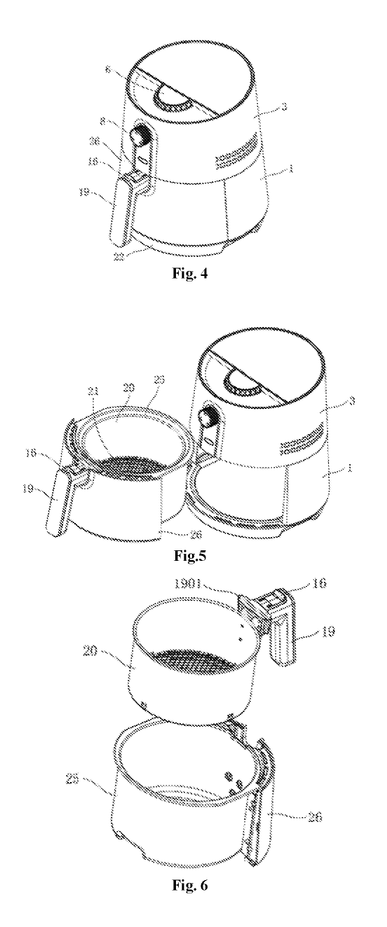

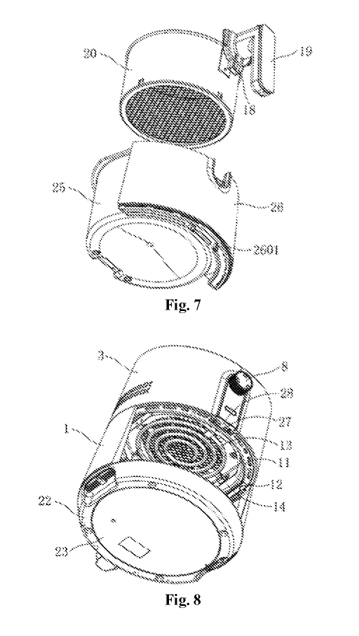

Turning to the drawings, and further description of structure and usage of the invention is provided. As shown in FIG. 1-8, the pot body of the air fryer is integrated by pot housing 26, outer pot 25, inner pot 20 and handle 19, specific as: the outer pot is connected with pot housing through the screw, and one side of the inner pot inside the outer pot is connected with handle through connecting pieces15. The handle and the pot housing are connected through locking plate18. The locking plate is L-shaped, with one end stick into the pot housing and fit with the metal sheet on the inner wall of the pot housing, and the other end against the locking sheet16 through tilted cover17. The locking sheet at the handle side is tilted. The shaft end of the tilted cover insert into the plate hole of the locking plate, and the pivot at the curved point of the locking plate is fixed in the handle. When pressing the locking sheet, the locking plate will be driven by the tilted cover to rotate, and the locking part of the locking plate will be separated from the metal sheet. In the same time, the center of inner diameter bottom of the outer spot is raised, and the inner diameter bottom of inner pot is equipped with oil-filter screen21 that is fixed by the clips inside the hole of inner pot. The hole of the inner pot is equipped with small eave whose diameter is smaller than the diameter of the oil filter screen. The bottom of the pot housing is equipped with housing hook2601, and the base22 corresponding to the hook is equipped with hood hole; when place the pot body into the engine body, the housing hook will be fit with hook hole of the base. The handle at eave of the said housing is equipped with raised limiting diagonal bar1901, the upper casing3 corresponding to the limiting diagonal bar of the handle is equipped with column plate28, and the limiting column27 inside the upper casing sticks out of column plate through the spring, and meets the beveled side of the limiting diagonal bar.

The upper casing1, lower casing3 and base22 are integrated into the engine body. The base is equipped with bottom cover23. The side of base symmetrical with the handle is equipped with splicing sleeve24, and the pot body is placed in the opening of one lower side of the engine body. The pot housing26 is arc-shaped; the pot housing and the engine body form a complete conical body which is small at the top and big at the bottom. The handle is appeared out of the engine body. The upper part of the engine body is equipped with spiral electric heating pipe14 and blade motors whose spindle is connected with cold-air blade7 and hot-air blade10. Blow hot air inside the engine body into the inner spot by rotating cold-air blade and hot-air blade, and then be discharged. The cold air goes into the engine body, one part of the cold air be discharged, and the rest be heated to hot air. The specific structures are as follows: the hemline of the outer pot25 beside the handle19 is equipped with flat key edges symmetrically, and flat key edges are corresponding to the through hole inside the upper casing. The through hole is located between inner diameter of interlayer cover11 and the external diameter of the heat shield cover. At two sides of upper casing above the through holes are symmetrical upper air-holes, and the base22 at two sides of splicing sleeves are equipped with lower air-holes. The gap between inner diameter of heat shield cover and external diameter of heating tube cover12, and the heating tube is opposed to the pot mouth. The said gap between heat shield cover and heating tube cover is connected with external diameter of engine body through air outlet plate2 which is located at one side of the engine body symmetrical to the handle.

In the same time, the cold-air blade and hot-air blade inside the upper casing is separated by the heat shield cover. The said cold-air blade and hot-air blade are plane blades with tilted back blades respectively. The back blade for cold-air blade is tilted upward; while back lade for hot-air blade is tilted downward. Meanwhile, the back blades are equipped with oriented punching tray respectively. The hot-air blade inside the upper casing is opposed to the air inlet hole of the heating tube cover. The air inlet hole of the heating tube pipe is equipped with hot-air mesh13, the spiral heating tube is equipped inside the heating tube cover. The controller and blade motor are equipped inside the cavity between outer diameter of interlayer cover and inner diameter of upper casing. The upper casing top and the upper cover4 are inclined to the handle. The upper cover at the top of upper casing is equipped with temperature switch6, which is partly appeared out of the arc-shaped groove at the top of upper casing. The upper casing at the handle side is equipped with time switch8 that is located at the engine body above the handle. Spiral electrical heating tube, temperature switch, time switch and blade motor are connected with controller through the line. The upper casing between time switch and handle is equipped with indicator light, and base at two sides of the handle is equipped with corner groove respectively. The limiting column is equipped inside the independent cavity of the upper engine body.

When using the fryer, firstly, place the oil filter screen21 into the inner pot20, and fix it at the clip; then pour the oil into the inner pot, and place the inner pot into the outer pot25. Insert the locking plate18 of the handle into the pot housing26 of the outer pot. Fit the locking plate with the metal sheet on the inner wall of the pot housing. The pot housing, outer pot, inner pot and handle are integrated. Place the food on the oil filter screen of the inner spot, and place the said integrated pot body into the port at one lower side of the engine body through handle. Fit the housing. hook of the pot housing with hook hole of the base. Complete the installation with a click sound. Finally, adjust the temperature at temperature switch, and time at time switch. After the food processing, tilt the body pot downward and outward through the handle, and extract the pot; and the pot body is able to be taken out when the housing hook of the pot housing is separated from the hook hole of the base, and the limiting diagonal bar of the handle is separated from the limiting column.

1. An air fryer, comprising lower casing, upper casing, blade motor, temperature switch, cold-air blade, hot-air blade, spiral electric heating tube, handle, inner pot, base, bottom cover outer pot, pot housings; the said pot housing, inner pot, outer pot and handle are integrated into the pot body, while upper casing, lower casing and base are integrated into the engine body. The base is equipped with bottom cover. The side of base symmetrical with the handle is equipped with splicing sleeve, and the pot body is placed in the opening of one lower side of the engine body. The pot housing is arc-shaped; the pot housing and the engine body form a complete conical body which is small at the top and big at the bottom. The handle is appeared out of the engine body. The upper part of the engine body is equipped with spiral electric heating pipe and blade motor whose spindle is connected with cold-air blade and hot-air blade. Blow hot air inside the engine body into the inner spot by rotating cold-air blade and hot-air blade, and then be discharged. The cold air goes into the engine body, one part of the cold air be discharged, and the rest be heated to hot air; is characterized in that the hemline of the outer pot beside the handle is equipped with flat key edges symmetrically, and flat key edges are corresponding to the through hole inside the upper casing. The through hole is located between inner diameter of interlayer cover and the external diameter of the heat shield cover. At two sides of upper casing above the through holes are symmetrical upper air-holes, and the base at two sides of splicing sleeves is equipped with lower air-holes. The gap between inner diameter of heat shield cover and external diameter of heating tube cover, and the heating tube is opposed to the pot mouth. The said gap between heat shield cover and heating tube cover is connected with external diameter of engine body through air outlet plate which is located at one side of the engine body symmetrical to the handle; the cold-air blade and hot-air blade inside the upper casing is separated by the heat shield cover, and the hot-air blade inside the upper casing is opposed to the air inlet hole of the heating tube cover. The air inlet hole of the heating tube is equipped with hot-air mesh, and the spiral heating tube is equipped inside the heating tube cover. The controller and blade motor are equipped inside the cavity between outer diameter of interlayer cover and inner diameter of upper casing. The upper casing top and the upper cover are inclined to the handle. The upper cover at the top of upper casing is equipped with temperature switch, which is partly appeared out of the arc-shaped groove at the top of upper casing. The upper casing at the handle side is equipped with time switch that is located at the engine body above the handle. Spiral electrical heating tube, temperature switch, time switch and blade motor are connected with controller through the line.

2. The said air fryer according to claim 1, wherein the center of inner diameter bottom of the outer spot is raised, and the inner diameter bottom of inner pot is equipped with oil-filter screen that is fixed by the clips inside the hole of inner pot. The hole of the inner pot is equipped with small eave whose diameter is smaller than the diameter of the oil filter screen.

3. The said air fryer according to claim 1, wherein The said outer pot is connected with pot housing through the screw, and one side of the inner pot inside the outer pot is connected with handle through connecting pieces. The handle and the pot housing are connected through locking plate. The locking plate is L-shaped, with one end stick into the pot housing and fit with the metal sheet on the inner wall of the pot housing, and the other end against the locking sheet through tilted cover. The locking sheet at the handle side is tilted. The shaft end of the tilted cover insert into the plate hole of the locking plate, and the pivot at the curved point of the locking plate is fixed in the handle. When pressing the locking sheet, the locking plate will be driven by the tilted cover to rotate, and the locking part of the locking plate will be separated from the metal sheet.

4. The said air fryer according to claim 1, wherein the bottom of the pot housing is equipped with housing hook, and the base corresponding to the hook is equipped with hood hole; when place the pot body into the engine body, the housing hook will be fit with hook hole of the base.

5. The said air fryer according to claim 1, wherein the handle at eave of the said housing is equipped with raised limiting diagonal bar, the upper casing corresponding to the limiting diagonal bar of the handle is equipped with column plate, and the limiting column inside the upper casing sticks out of column plate through the spring, and meets the beveled side of the limiting diagonal bar.

6. The said air fryer according to claim 1, wherein the said cold-air blade and hot-air blade are plane blades with tilted back blades respectively. The back blade for cold-air blade is tilted upward; while back lade for hot-air blade is tilted downward. Meanwhile, the back blades are equipped with oriented punching tray respectively.

7. The said air fryer according to claim 1, wherein upper casing between time switch and handle is equipped with indicator light, and base at two sides of the handle is equipped with corner groove respectively.
